(19) United States
(12) Patent Application Publication
(10) Pub. No.: US 2025/0360574 A1
(43) Pub. Date: Nov. 27, 2025

(54) USE OF ONE OR MULTIPLE CAMERAS TO DO REAL-TIME SOLDER NOZZLE PROCESS ANALYZATION

(71) Applicant: Nordson Corporation, Westlake, OH (US)

(72) Inventors: Erik POORTMAN, Singapore (SG); Florian STROHMAYHER, Karlsruhe (DE)

(73) Assignee: Nordson Corporation, Westlake, OH (US)

(21) Appl. No.: 18/998,605

(22) PCT Filed: Jul. 28, 2023
(86) PCT No.: PCT/US2023/071173

§ 371 Date: Jan. 27, 2025

Related U.S. Application Data
(60) Provisional application No. 63/392,888, filed on Jul. 28, 2022.

(51) Int. Cl. B23K 3/08; B23K 3/06

(52) U.S. Cl. CPC B23K 3/08; B23K 3/0653

(57) ABSTRACT

A selective soldering machine configured to adjust a solder wave provided by a selective soldering nozzle based on at least one property detected by an image sensor of the selective soldering machine. The selective soldering nozzle may be configured to provide a solder wave to solder a portion of a workpiece. The image sensor may be configured to detect at least one property of the selective soldering nozzle and/or the solder wave in real-time. The selective soldering machine may include a controller that is configured to adjust the solder wave provided by the selective soldering nozzle based on the at least one property detected by the image sensor.

### CROSS-REFERENCE TO RELATED APPLICATIONS

This application is a National Stage Application of International Patent App. No. PCT/US2023/071173, filed Jul. 28, 2023, which claims the benefit of U.S. Provisional Patent App. No. 63/392,888, filed Jul. 28, 2022, the entire disclosures of both of which are hereby incorporated by reference as if set forth in their entirety herein.

### TECHNICAL FIELD

The disclosure relates to a selective soldering machine and method for applying molten solder to a workpiece, and more particularly relates to a selective soldering machine and method for adjusting a solder wave based on real-time visual images of the solder wave.

### BACKGROUND

In a wave soldering machine a printed circuit board (“PCB”) is moved by a conveyor over the top of a stationary wave solder nozzle, which spans an entire width of the PCB. Components disposed on a bottom side of the PCB that are heat sensitive must be shielded by a protective fixture. Also, PCBs that have components disposed on the bottom side that exceed a predetermined height (e.g., over a quarter of an inch high) cannot be soldered on a wave soldering machine because these components would collide with the wave solder nozzle during operation.

In contrast, selective soldering machines are advantageous in that they can apply molten solder to individual pins of a component on a substrate, or groups of pins, without disturbing other components that need not be soldered or cannot withstand, for example, the heat producing effects of wave soldering machines. With selective soldering, a small fountain (e.g., column) of solder is provided/formed using a selective soldering nozzle that is oriented vertically, and the nozzle and the fountain of solder are selectively raised to engage PCB hole through which the pin of a component extends, or grouping of pins/holes extend. In this regard, the fountain of solder accordingly applies solder to the pin of the component or grouping of pins of the component. The selective solder nozzles may be wettable, and thus solder may stick to the surface of the corresponding selective solder nozzle as the solder flows upward through an output of the corresponding selective solder nozzle and then downward along a side of the corresponding selective solder nozzle.

However, variations in wave properties (e.g., wave height) from an ideal can result in imperfect soldering of such a pin or grouping of pins.

### SUMMARY

The present application provides for a selective soldering machine configured to adjust a solder wave provided by a selective soldering nozzle based on at least one property detected by an image sensor of the selective soldering machine. The selective soldering nozzle may be configured to provide a solder wave to solder a portion of a workpiece. The image sensor may be configured to detect at least one property of the selective soldering nozzle and/or the solder wave in real-time. The selective soldering machine may include a controller that is configured to adjust the solder wave provided by the selective soldering nozzle based on the at least one property detected by the image sensor.

According to an embodiment of the present disclosure, a selective soldering machine comprises a selective soldering nozzle configured to provide a solder wave to solder a portion of a workpiece. The selective soldering machine may comprise at least one image sensor configured to detect at least one property of the selective soldering nozzle and/or the solder wave in real-time. The selective soldering machine may comprise a controller that is configured to adjust the solder wave provided by the selective soldering nozzle based on the at least one property detected by the at least one image sensor.

According to another embodiment of the present disclosure, a method of applying solder to a workpiece may comprise providing a solder wave with a selective soldering nozzle. The method may comprise detecting, with at least one image sensor, at least one property of the selective soldering nozzle and/or the solder wave in real-time. The method may comprise adjusting, with a controller, the solder wave provided by the selective soldering nozzle based on the at least one property detected by the at least one image sensor.

### BRIEF DESCRIPTION OF THE DRAWINGS

The foregoing summary, as well as the following detailed description of illustrative embodiments of the selective soldering machine of the present application, will be better understood when read in conjunction with the appended drawings. For the purposes of illustrating the selective soldering machine of the present application, there is shown in the drawings illustrative embodiments. It should be understood, however, that the application is not limited to the precise arrangements and instrumentalities shown. In the drawings:

FIG. 1 is an oblique view of a selective soldering machine according to aspects of the disclosure;

FIG. 2 is an oblique view of a soldering area of the selective soldering machine of FIG. 1;

FIG. 3 is a side view of the selective soldering machine of FIG. 1 including a nozzle and a schematic representation of a camera;

FIG. 4 is a front view of a displayed interface screen for monitoring and/or controlling the selective soldering machine;

FIG. 5 is a front view of a displayed screen including multiple camera views of solder waves;

FIGS. 6A-6F are each a front view of a displayed screen including multiple camera views at various stages throughout a solder wave adjusting process of multiple selective soldering nozzles;

FIG. 7 is a front view of multiple representations of a solder wave and a corrected solder wave;

FIG. 8 is a front view of a portion of a displayed screen including a camera view and properties of the selective soldering nozzle and the solder wave;

FIG. 9 is a diagram representing wave height, pump speed, and pump speed error over time; and

FIG. 10 is a wave height check control block diagram.

### DETAILED DESCRIPTION OF ILLUSTRATIVE EMBODIMENTS

The present disclosure can be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the scope of the present disclosure. Also, as used in the specification including the appended claims, the singular forms “a,” “an,” and “the” include the plural, and reference to a particular numerical value includes at least that particular value, unless the context clearly dictates otherwise.

The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

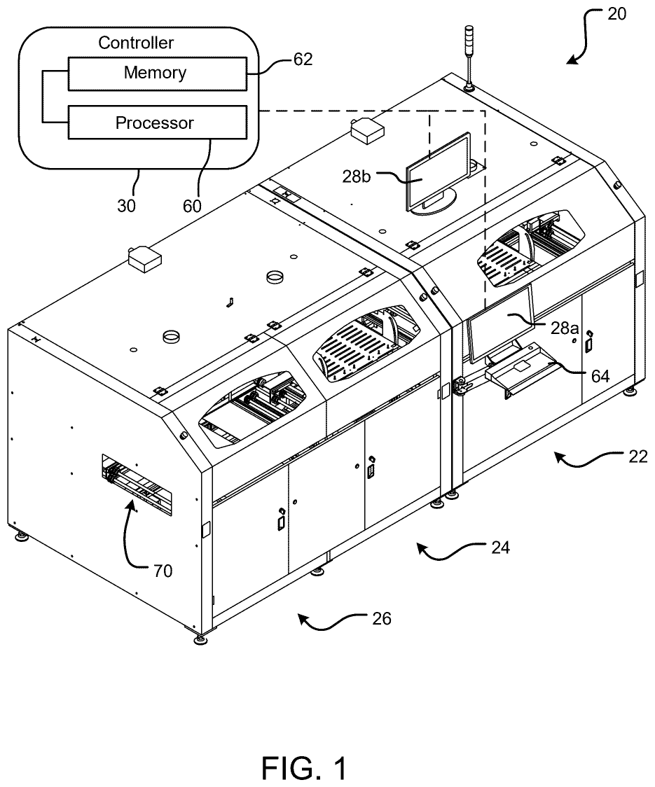

Current systems for checking solder nozzle quality are limited to checking the solder wave height by measuring it against a fixed sensor or probe at certain intervals and by an operator visually checking a video stream. The selective soldering machine 20 illustrated in FIG. 1 may include a selective soldering area 22, a heating area 24, a flux application area 26. The selective soldering machine 20 may include a controller 30, which is schematically represented in FIG. 1. The controller 30 may be operatively coupled to the selective soldering area 22, the heating area 24, and/or the flux application area 26, such that the controller 30 is configured to control the selective soldering area 22, the heating area 24, and/or the flux application area 26.

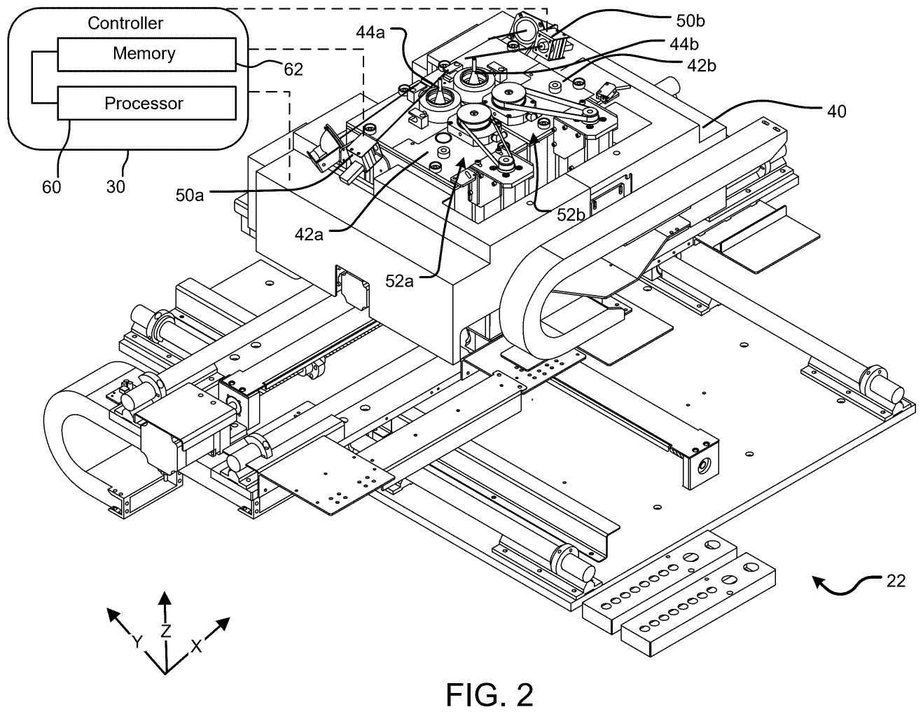

Referring now to FIG. 2, the selective soldering area 22 may include a movable selective solder body 40, one or more solder pots 42a, 42b, one or more selective soldering nozzles 44a, 44b, and one or more image sensors 50a, 50b (e.g., cameras).

Each image sensor 50a, 50b may be configured to check many process values related to the solder nozzle quality such as (but not limited to): size, height, correct position in the riser, solder wave height, solder wave shape, nozzle body flow, and/or oxidation level.

The controller 30 may be operatively coupled with each image sensor 50a, 50b, such that the controller 30 is configured to receive image data from each image sensor 50a, 50b, as schematically represented with dashed lines in FIG. 2. For example, the controller 30 may be configured to control one or both solder pots 42a, 42b, and/or one or both selective soldering nozzles 44a, 44b based on the image data. In an embodiment, the controller is operatively coupled to one or more of the selective soldering nozzles 44a, 44b and one or more of the image sensors 50a, 50b.

The controller 30 may be operatively coupled to one or more displays 28a, 28b of the selective soldering machine 20, as represented with dashed lines in FIG. 1. For example, the controller 30 may be configured to communicate with one or both displays 28a, 28b.

The image data may be collected and analyzed in real-time (e.g., by the controller 30) without an operator present and actions will be taken by the controller 30 automatically 30. For example, the controller 30 may operate software to either automatically correct the issue or stop/pause the machine to inform the operator.

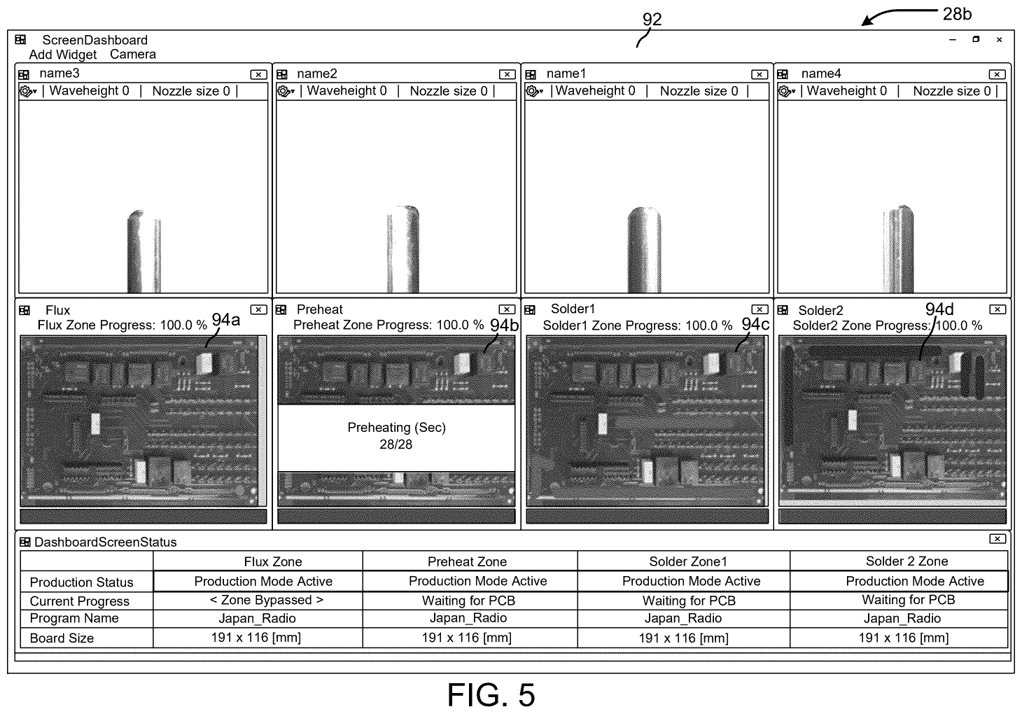

Each selective soldering nozzle 44a, 44b may be configured to provide a solder wave to solder a respective portion of a workpiece (e.g., workpiece 94a shown in FIG. 5). For example, each solder wave may be generated at an outlet of the corresponding selective soldering nozzle 44a, 44b. One or more pumps 52a, 52b may be configured to generate each solder wave by pumping solder from one or more solder pots 42a, 42b to the corresponding selective soldering nozzle 44a, 44b. The pumps 52a, 52b may be part of the respective solder pot 42a, 42b.

Each selective soldering nozzle 44a, 44b may move along a machine direction (e.g., along a longitudinal axis X), a direction orthogonal to the machine direction (e.g., along a lateral axis Y), and/or along a vertical direction (e.g., along a vertical axis Z) that is orthogonal to both the machine direction and the direction orthogonal to the machine direction to selectively apply solder to the workpiece (e.g., at bottoms thereof).

The image sensors 50a, 50b (e.g., at least one, at least two, or more than two image sensors) may each be configured to detect at least one property of the selective soldering nozzle and/or the solder wave in real-time. For example, each of the image sensors 50a, 50b may be configured to detect at least one of a size of the selective soldering nozzle 44a, 44b, a height of the selective soldering nozzle 44a, 44b, a position of the selective soldering nozzle 44a, 44b in a riser, a size of the solder wave, a height of the solder wave, a shape of the solder wave, a nozzle body flow, and/or oxidation level of the solder wave.

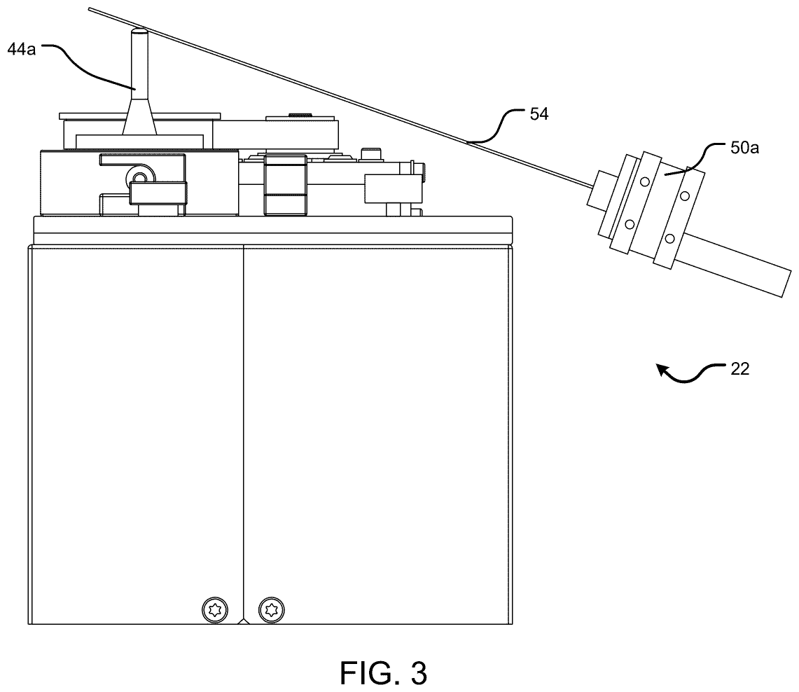

The image sensors 50a, 50b may each be directed to the corresponding selective soldering nozzle 44a, 44b. For example, each image sensor 50a, 50b may have a respective line of sight 54 (represented in FIG. 3), which may be directed to the outlet of the corresponding selective soldering nozzle 44a, 44b (e.g., in the manner represented in FIG. 3 for the image sensor 50a and the corresponding selective soldering nozzle 44a).

Detecting in real-time includes detecting at least every 0.2 seconds. For example, each image sensor may detect at least one property of the selective soldering nozzle and/or the solder wave every 0.001 to 0.2 seconds. In some embodiments, detecting the at least one property in real-time includes detecting the at least one property at least every 1 second, 0.1 seconds, 0.01 seconds, 0.001, and/or 0.0001 seconds.

The controller 30 may be configured to adjust the solder wave provided by the corresponding selective soldering nozzle 44a, 44b based on the at least one property detected by the image sensors 50a, 50b. The controller 30 may be configured to adjust the solder wave based on at least one of the size of the selective soldering nozzle 44a, 44b, the height of the selective soldering nozzle 44a, 44b, the position of the selective soldering nozzle 44a, 44b in the riser, the size of the solder wave, the height of the solder wave, the shape of the solder wave, the nozzle body flow, and/or the oxidation level of the solder wave.

The controller 30 may be configured to analyze each frame of image data detected by at least one image sensor 50a, 50b to determine whether to adjust the solder wave, and the controller 30 may be configured to adjust the solder wave in response to determining that the solder wave should be adjusted. In an embodiment, the selective soldering machine 20 (e.g., the controller 30 of the selective soldering machine 20) may take a video stream of a camera (an example of an image sensor) and, every frame of the video stream, may analyze the data (e.g., any one of or any combination of the properties discussed above). The selective soldering machine 20 (e.g., the controller 30), may then apply filters and algorithms to determine any one of or all of the process values. The selective soldering machine 20 (e.g., the controller 30) may then feedback the data to the software to allow it to act accordingly (e.g., to adjust the solder wave).

The controller 30 may be configured to provide a prompt to an operator in response to determining that the solder wave should be adjusted. The controller 30 may include a processor 60, a memory 62, a display (e.g., one or both of displays 28a, 28b), a user interface 64 (e.g., a keyboard), and the like. The processor 60 may be a central processing unit, microprocessor, dedicated hardware, or the like configured to execute instructions including instructions related to software programs. In one aspect, the controller may be implemented with a wireless phone or the like configured to provide the additional functionality as defined herein.

Each display 28a, 28b may be a liquid crystal display having a backlight to illuminate the various color liquid crystals to provide a colorful display. The displays 28a, 28b may each be a light-emitting diode display (LED), an electroluminescent display (ELD), a plasma display panel (PDP), a liquid crystal display (LCD), an organic light-emitting diode display (OLED), a Quantum dot LED (QLED), or any other display technology.

The user interface 64 may be any type of physical input having one or more buttons, switches, and the like and/or may be implemented as a touchscreen.

The controller 30 may further include in the memory 62 or separate from the memory 62, a computer readable memory, an operating system, a communication component, a contact/motion component, a touchscreen controller, a graphics component and the like. The operating system together with the various components providing software functionality for each of the components of the controller. The controller may further include a read-only memory (ROM) and a power supply.

The memory 62 may include a high-speed random-access memory. Also, the memory 62 may be a non-volatile memory, such as magnetic fixed disk storage, flash memory or the like. The various components of the controller may be connected through various communication lines including a data bus. Additionally, the controller 30 may include an input/output device. The input/output device may include an analog to digital converter and a digital to analog converter.

Each image sensor 50a, 50b can capture video in combination with an input/output device. The image sensor 50a, 50b may include a charge coupled device (CCD), CMOS image sensors, Back Side Illuminated CMOS, and/or the like. Images captured by the image sensor 50a, 50b may be converted and stored in various formats. The image sensor 50a, 50b may include a lens.

Referring to FIG. 1, the selective soldering machine 20 may include a conveyor 70. The conveyor 70 may be configured to move one or more workpieces (not shown) along the machine direction, for example. The workpiece may be PCB that may include a plurality of exposed component pins. The workpiece may be continuously conveyed by the conveyor 70 along the machine direction through the flux application area 26, the heating area 24, and the selective soldering area 22, in that order. The controller 30 may control the conveyor 70 to continuously convey the workpieces through the flux application area 26, the heating area 24, and the selective soldering area 22 to control the application of flux, heat, and/or solder at each respective area.

The selective soldering machine 20, compared to prior machines, may add much more process data in real-time that can be used to determine solder nozzle quality without the need of an operator monitoring the video stream. The selective soldering machine 20 also may not require a fixed sensor or probe that the selective soldering nozzles 44a, 44b need to travel to for verification of the respective nozzle heights in some prior selective soldering systems.

Since the selective soldering machine 20 works (e.g., the image sensors 50a, 50b provide image data of the selective soldering nozzles 44a, 44b and/or the solder waves) in real-time, it also removes the need to travel to a certain position in the machine, which may provide for reducing cycle time.

The selective soldering machine 20 may advantageously greatly improve the overall soldering quality of the process. The selective soldering machine may advantageously reduce the overall cost of the machine. The selective soldering machine may advantageously provide much more data to the user/customer about the solder nozzle. The selective soldering machine may advantageously improve cycle time and/or performance of the solder nozzle/wave condition.

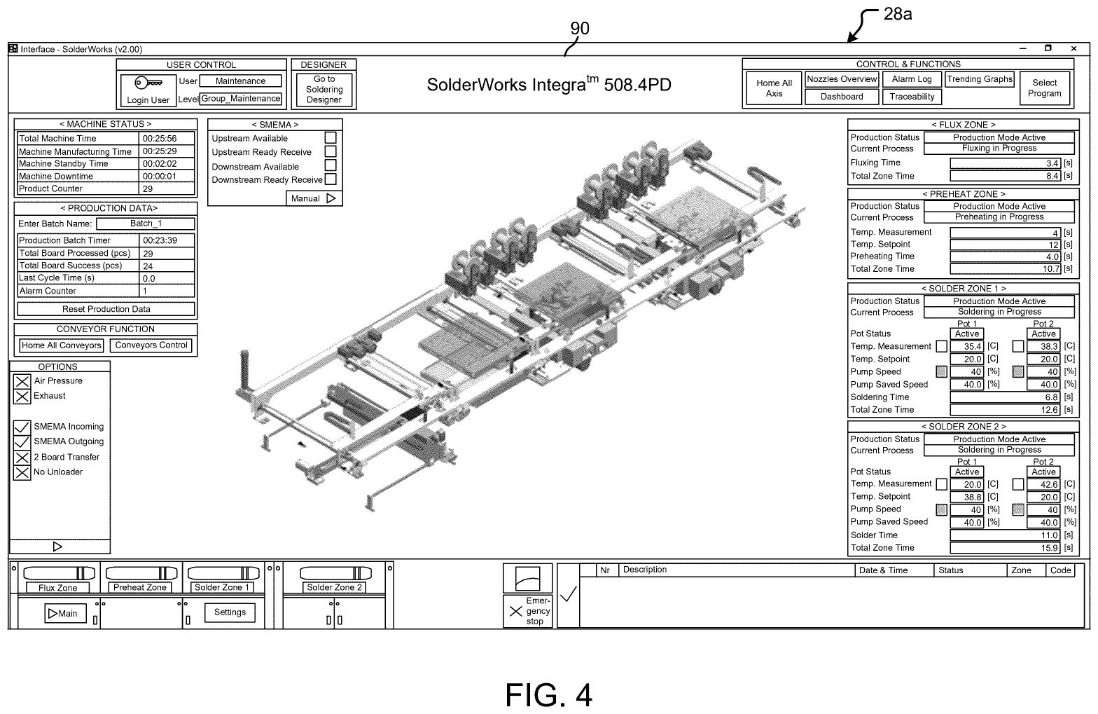

Referring now to FIG. 4, the display 28a may be configured to display an interface screen 90. For example, the interface screen 90 may include a representation of the selective soldering machine 20 along with representations of various control settings and/or properties of the selective soldering machine 20. The control settings and/or properties may relate to the selective soldering area 22 (also referred to as a solder zone), the heating area 24 (also referred to as a preheat zone), the flux application area 26 (also referred to as a flux zone), and/or the conveyor 70, shown in FIG. 1.

Turning to FIG. 5, the other display 28b may be configured to display a first dashboard screen 92. The first dashboard screen 92 may include multiple camera views of solder waves produced by corresponding selective soldering nozzles of the selective soldering machine 20 in real-time. The first dashboard screen 92 may include multiple camera views of one or more workpieces 94a-94b at various stages within the selective soldering machine 20, along with status details of each zone of the selective soldering machine 20.

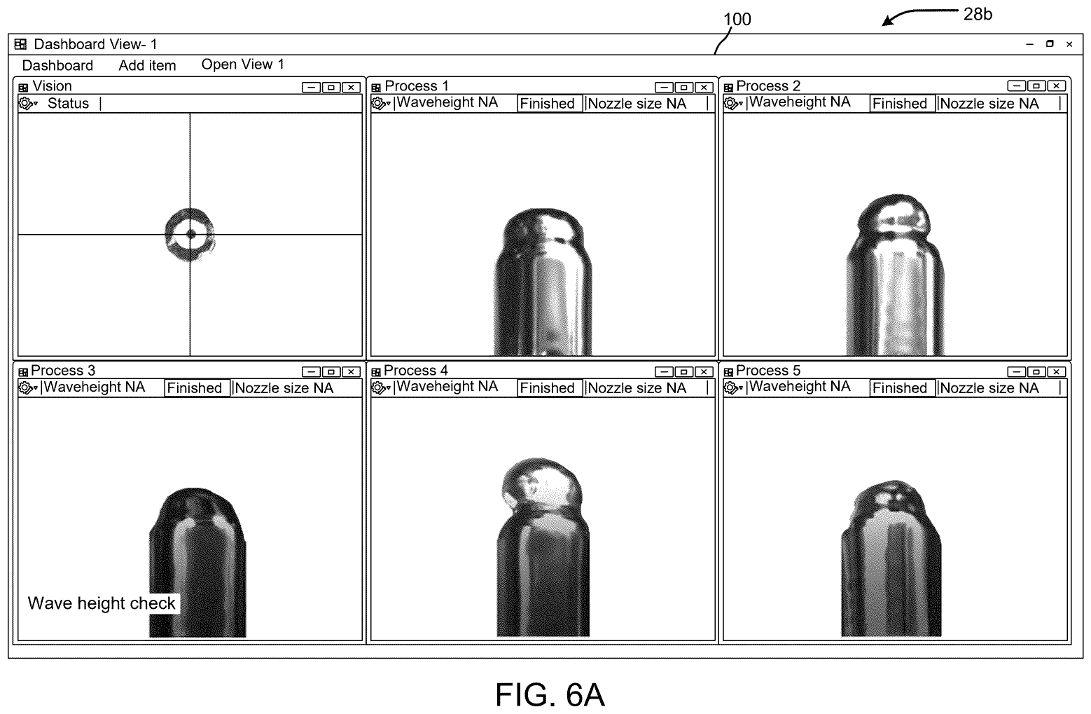

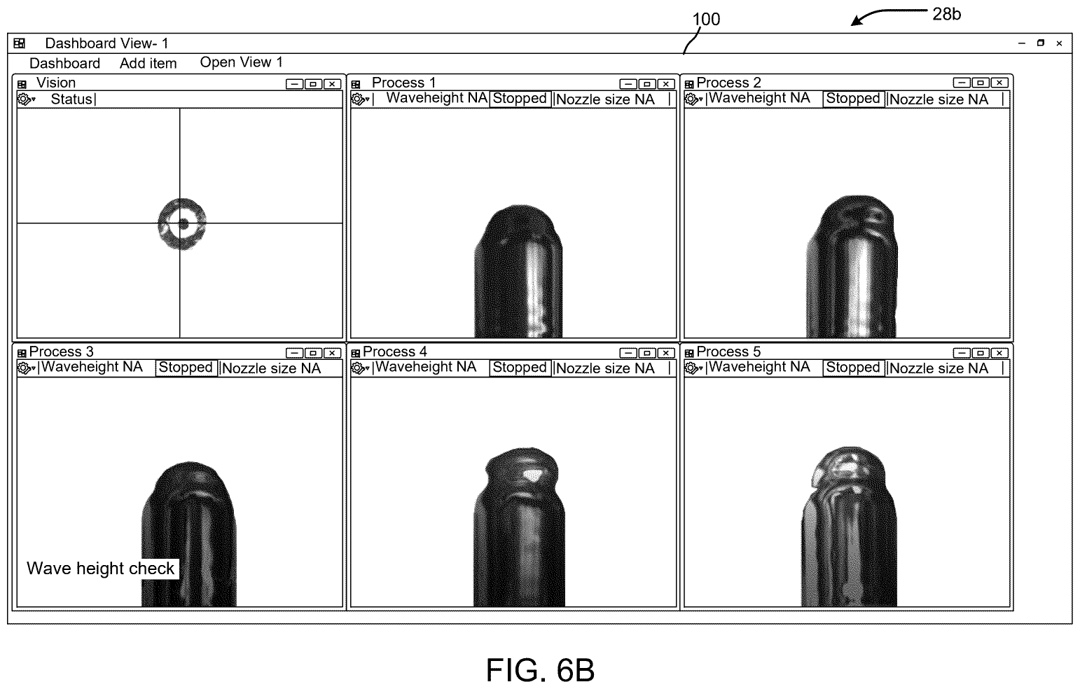

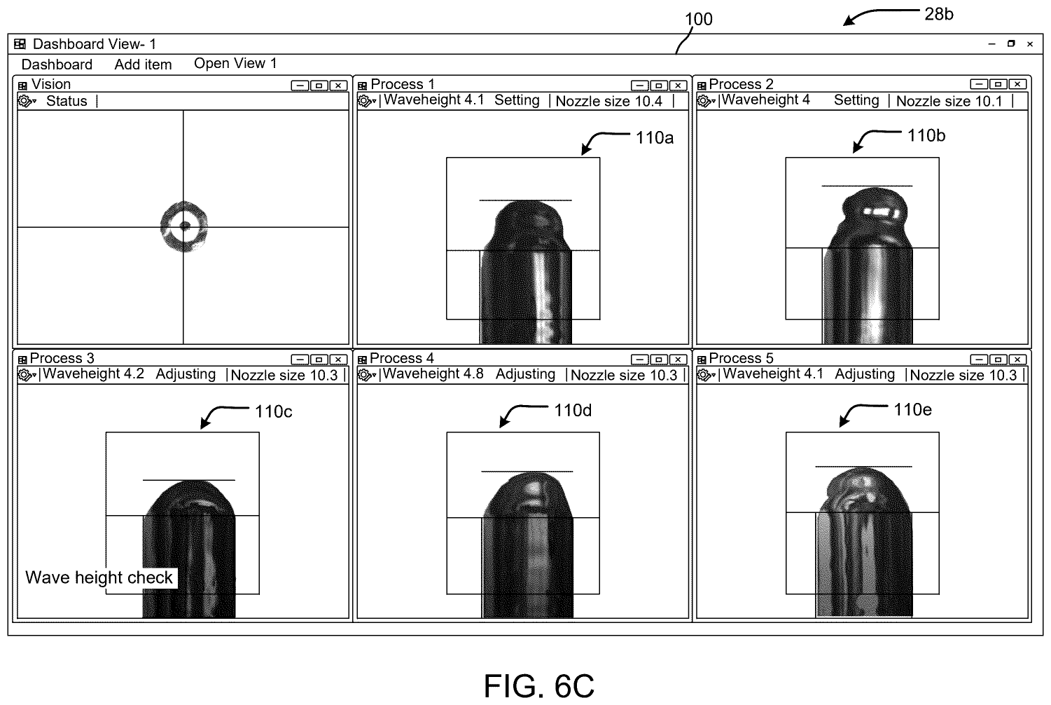

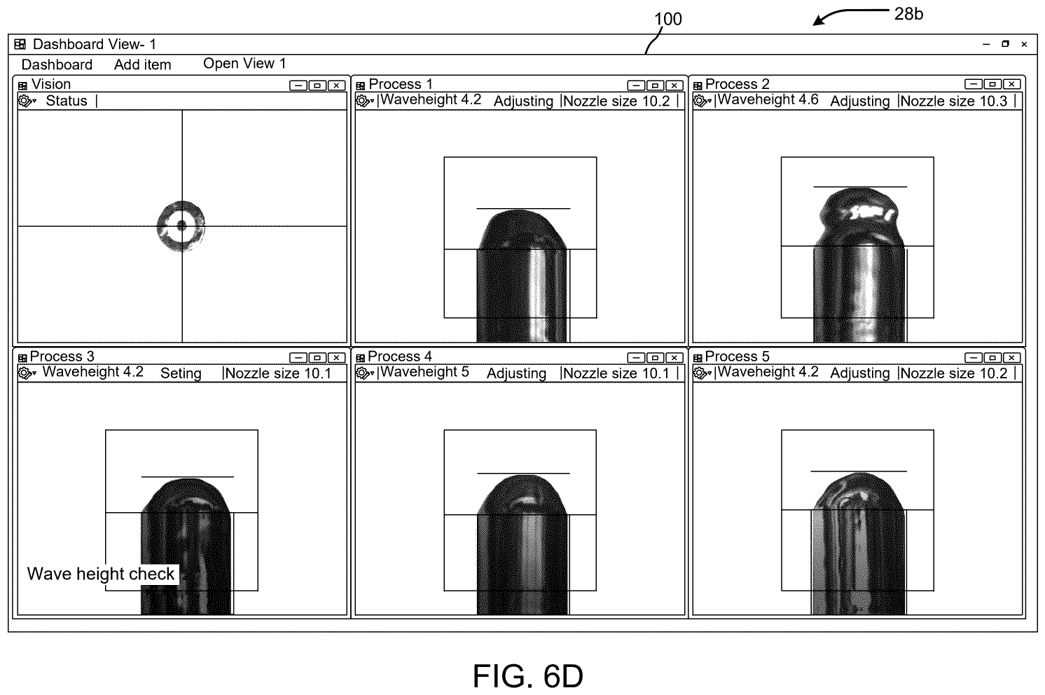

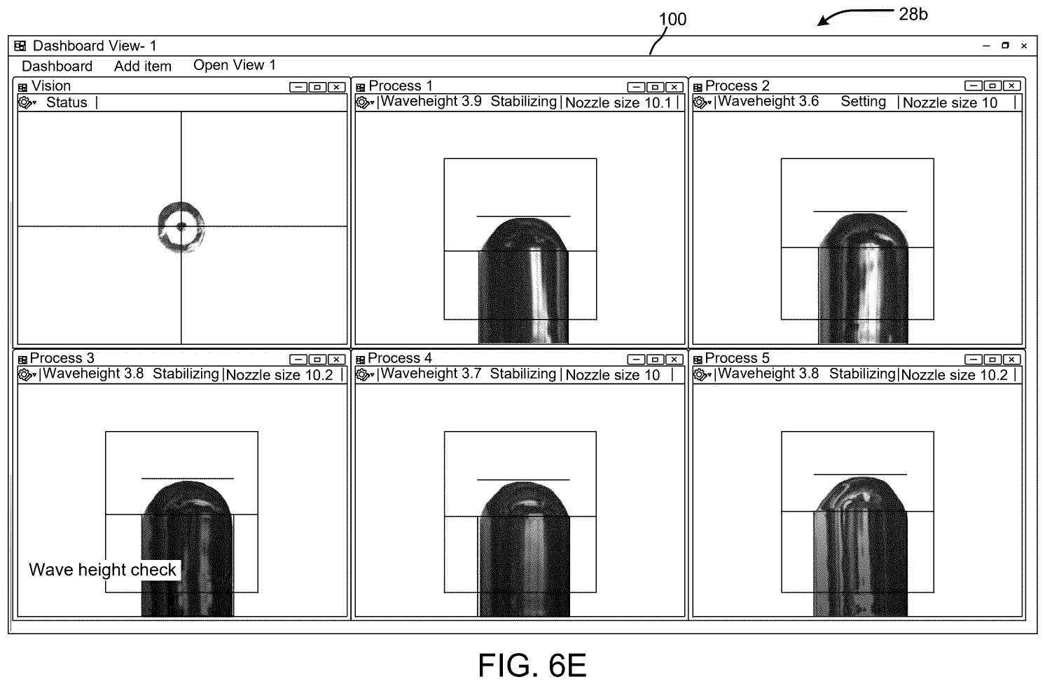

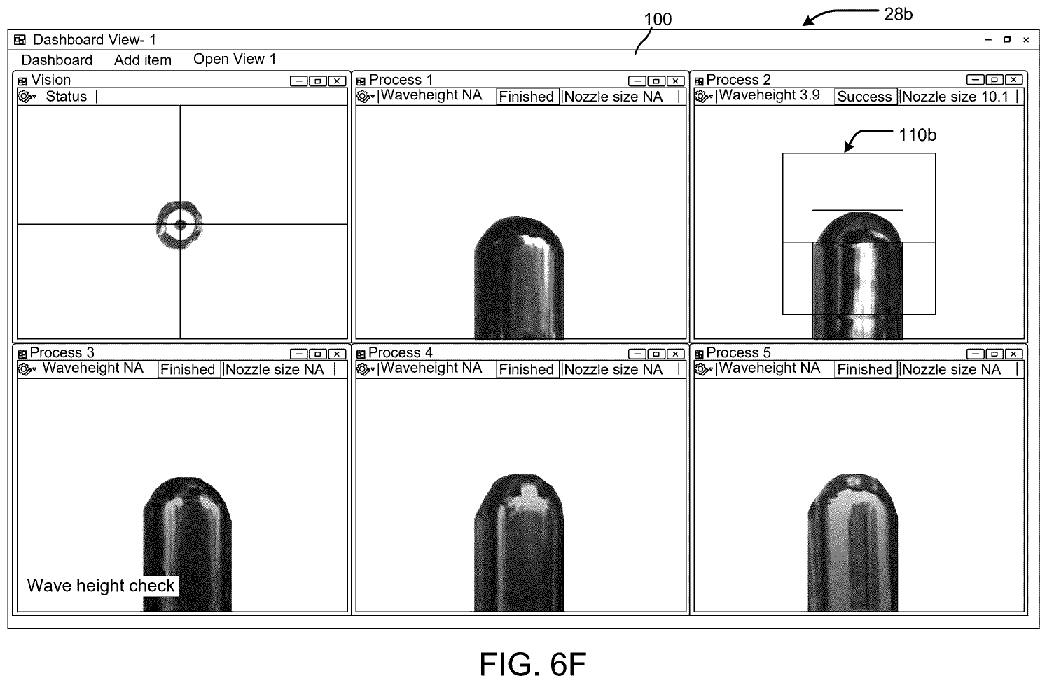

Turning to FIGS. 6A-6F, the other display 28b may be configured to display an adjustment dashboard screen 100 that includes one or more camera views of the solder waves produced by corresponding selective soldering nozzles of the selective soldering machine 20 in real-time at various stages of a solder wave adjusting process. FIGS. 6A-6F provide representations of a transition of the camera views through the solder wave adjusting process. In an embodiment, one or more camera views are represented on the adjustment dashboard screen.

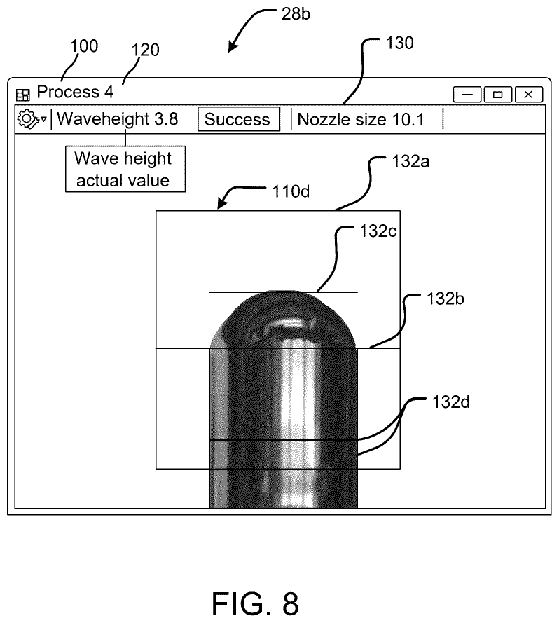

For example, in FIG. 6A the adjustment dashboard screen 100 includes a real-time representation of five different solder waves produced by corresponding selective soldering nozzles, prior to the solder wave adjusting process (e.g., after a prior soldering process has completed). In FIG. 6B the adjustment dashboard screen 100 includes a real-time representation of the five different solder waves at a second stage of the solder wave adjusting process, where each solder process of the different solder waves is stopped. In FIG. 6C the adjustment dashboard screen 100 includes a real-time representation of the five different solder waves at a third stage of the solder wave adjusting process, where the controller 30 measures the wave height of each solder wave. The adjustment dashboard screen 100 may include one or more representations 110a-110e (as discussed below with reference to FIG. 8) of the wave height measurement that may be displayed as mapped onto each respective solder wave, at the third stage. In FIG. 6D the adjustment dashboard screen 100 includes a real-time representation of the five different solder waves at a fourth stage of the solder wave adjusting process, where the controller 30 adjusts the wave height of each solder wave (e.g., to a predetermined wave height).

In FIG. 6E the adjustment dashboard screen 100 includes a real-time representation of the five different solder waves at a fifth stage of the solder wave adjusting process, where the controller 30 stabilizes the wave height of each solder wave (e.g., at the predetermined wave height). In FIG. 6F the adjustment dashboard screen 100 includes a real-time representation of the five different solder waves after the adjustment process is completed.

The adjustment dashboard screen 100 in FIG. 6F may include the representation 110b of wave height measurement generated by the controller 30 to verify the corresponding wave height is at the predetermined height.

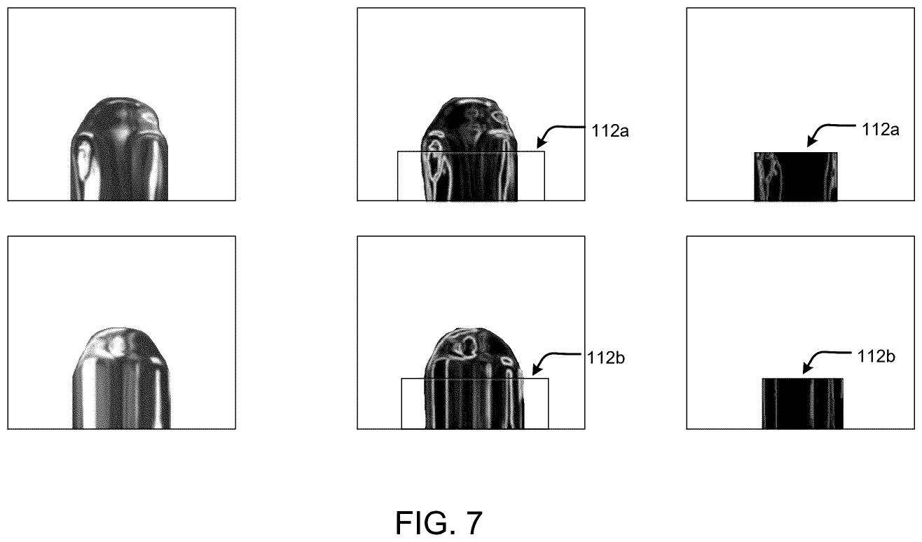

FIG. 7 provides additional examples of a solder wave that is adjusted (also referred to as corrected) to a predetermined height. As exemplified in FIG. 7, the controller 30 may crop a lower portion 112a, 112b of a representation of the solder wave for analysis and/or comparison to a predetermined threshold.

Turning to FIG. 8, each window of the adjustment dashboard screen 100 may include multiple properties and/or visual representations. For example, one window 120 of the adjustment dashboard screen 100 may include the representation 110d of the wave height measurement and a nozzle size 130. The representation 110d of the wave height measurement may be defined within a region of measurement 132a, and may include a top of nozzle reference 132b and a top of wave real-time representation 132c.

A nozzle size measurement 132d may be represented within the region of measurement 132a. In an embodiment, the wave height adjustment may not be based on the nozzle size measurement 132d.

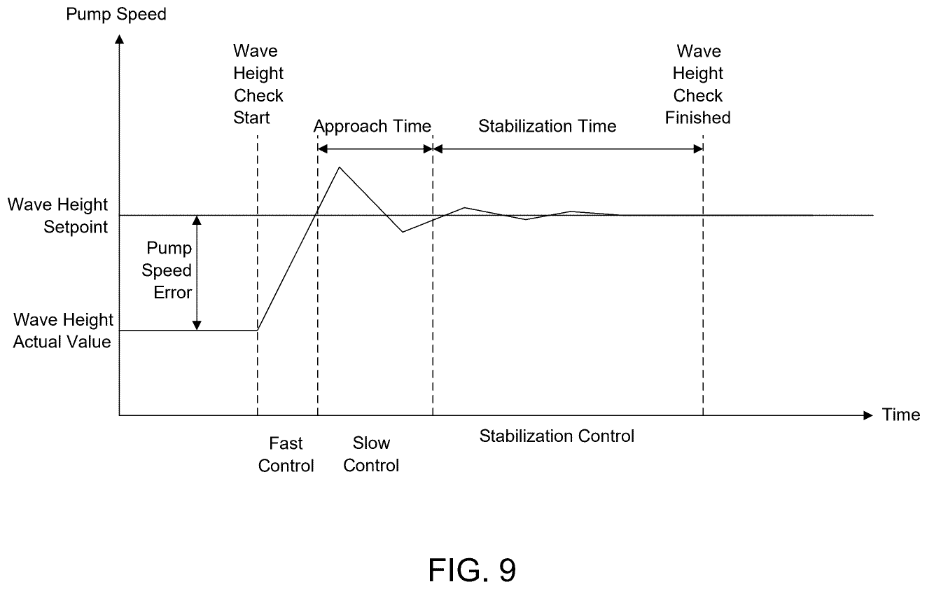

FIG. 9 illustrates a diagram representing wave height, pump speed, and pump speed error over time during the solder wave adjusting process. For example, the controller 30 may control the pump 52a to adjust the corresponding solder wave height to the predetermined wave height. As shown in FIG. 9, during a fast control period the controller 30 may increase a pump speed of the pump 52a to or above a wave height setpoint that corresponds to the predetermined wave height. At the end of the fast control period, the controller 30 may, during a slow control period, adjust (e.g., reduce and/or increase) the pump speed of the pump 52a more slowly than during the fast control period, to the wave height setpoint. After the slow control period, the controller 30 may perform stabilization control to arrive at the wave height setpoint such that the weight height remains at the wave height setpoint without significant variation when the wave height check is finished.

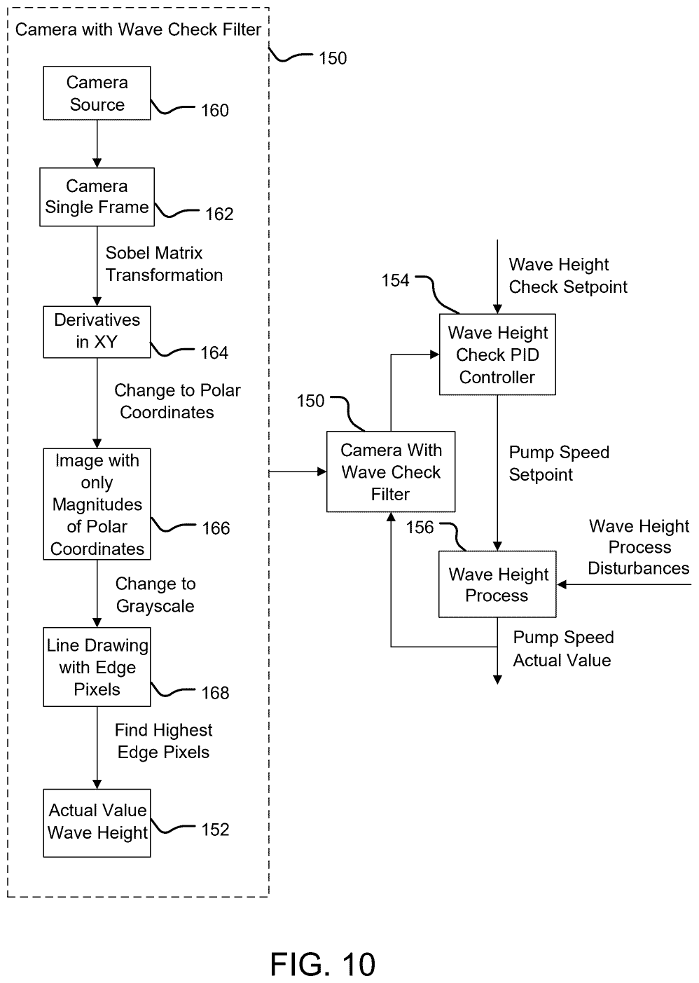

Turning to FIG. 10, an example of a wave height check control block diagram is schematically represented. For example, an image sensor (e.g., a camera) with a wave check filter block 150 may output an actual value wave height block 152 to a wave height check proportional-integral-derivative (“PID”) controller block 154. The wave height check PID controller block 154 may receive a wave height check setpoint that corresponds to the predetermined wave height and output a pump speed setpoint that is received by a wave height process block 156. Wave height process disturbances may be input to the wave height process block 156, which may provide a pump speed actual value.

The pump speed actual value may be input back into the image sensor with a wave check filter block 150. Thus, feedback of the pump speed actual value is provided to the image sensor with a wave check filter block 150, thereby providing for a second or more iterations of the above-described adjustment process.

The image sensor with a wave check filter block 150 may include an image source block 160 (e.g., a camera source block), which may provide an output to a camera single frame block 162. The camera single frame block 162 may provide an output that undergoes a Sobel matrix transformation (e.g., performed by the controller 30) and is provided to a derivatives in XY block 164. An output of the derivatives in XY block 164 may be changed to polar coordinates (e.g., by the controller 30), and received by an image with only magnitudes of polar coordinates block 166. An output of the image with only magnitudes of polar coordinates block 166 may be changed to grayscale and received by a line drawing with edge pixels block 168. The output of the line drawing with edge pixels block 168 may undergo a find highest edge pixels process that leads to the actual value wave height block 152.

The controller 30, may be configured to carry out the processes and/or functions of the wave height check control block diagram.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Further in accordance with various aspects of the disclosure, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

Aspects of the disclosure may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

Artificial intelligence and/or machine learning may utilize any number of approaches including one or more of cybernetics and brain simulation, symbolic, cognitive simulation, logic-based, anti-logic, knowledge-based, sub-symbolic, embodied intelligence, computational intelligence and soft computing, machine learning and statistics, and the like.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

The following are a number of nonlimiting EXAMPLES of aspects of the disclosure.

In one general aspect, selective soldering machine may include a selective soldering nozzle configured to provide a solder wave to solder a portion of a workpiece. The selective soldering machine may also include at least one image sensor configured to detect at least one property of the selective soldering nozzle and/or the solder wave in real-time. The selective soldering machine may furthermore include a controller that is configured to adjust the solder wave provided by the selective soldering nozzle based on the at least one property detected by the at least one image sensor. Other embodiments of this aspect include corresponding computer systems, apparatus, and computer programs recorded on one or more computer storage devices, each configured to perform the actions of the methods.

Implementations may include one or more of the following features. The selective soldering machine where the controller is configured to adjust the solder wave based on at least one of a size of the selective soldering nozzle, a height of the selective soldering nozzle, a position of the selective soldering nozzle in a riser, a size of the solder wave, a height of the solder wave, a shape of the solder wave, a nozzle body flow, and/or oxidation level of the solder wave. The selective soldering machine where the at least one image sensor is configured to detect at least one property of the solder wave in real-time. The selective soldering machine where the controller is configured to analyze each frame of image data detected by the at least one image sensor to determine whether to adjust the solder wave. The selective soldering machine where the controller is configured to adjust the solder wave in response to determining that the solder wave should be adjusted. The selective soldering machine where the controller is configured to provide a prompt to an operator in response to determining that the solder wave should be adjusted. The selective soldering machine may include a first solder pot that is configured to provide solder to the selective soldering nozzle. The selective soldering machine where the selective soldering nozzle is a first selective soldering nozzle; and where selective soldering machine further may include: a second selective soldering nozzle configured to provide a solder wave to solder another portion of the workpiece. The selective soldering machine where at least one other image sensor is configured to detect at least one property of the solder wave, provided by the second selective soldering nozzle, in real-time. The selective soldering machine where the controller is configured to adjust the solder wave provided by the second selective soldering nozzle based on the at least one property detected by the at least one other image sensor. The selective soldering machine may include a second solder pot that is configured to provide solder to the second selective soldering nozzle. Implementations of the described techniques may include hardware, a method or process, or a computer tangible medium.

In one general aspect, method may include providing a solder wave with a selective soldering nozzle. The method may also include detecting, with at least one image sensor, at least one property of the selective soldering nozzle and/or the solder wave in real-time. The method may furthermore include adjusting, with a controller, the solder wave provided by the selective soldering nozzle based on the at least one property detected by the at least one image sensor. Other embodiments of this aspect include corresponding computer systems, apparatus, and computer programs recorded on one or more computer storage devices, each configured to perform the actions of the methods.

Implementations may include one or more of the following features. The method where the controller adjusts the solder wave based on at least one of a size of the selective soldering nozzle, a height of the selective soldering nozzle, a position of the selective soldering nozzle in a riser, a size of the solder wave, height of the solder wave, a shape of the solder wave, a nozzle body flow, and/or oxidation level of the solder wave. The method may include: applying solder from the selective soldering nozzle to a target portion of a workpiece. The method where the at least one image sensor detects at least one property of the solder wave in real-time. The method where the controller adjusts the solder wave in response to determining that the solder wave should be adjusted. The method where the controller provides a prompt to an operator in response to determining that the solder wave should be adjusted. The method may include: providing solder to the selective soldering nozzle with a first solder pot. The method where the selective soldering nozzle is a first selective soldering nozzle, and where the method further may include: providing a solder wave to solder another portion of the workpiece with a second selective soldering nozzle. The method may include: detecting at least one property of the solder wave, provided by the second selective soldering nozzle, in real-time with at least one other image sensor. Implementations of the described techniques may include hardware, a method or process, or a computer tangible medium.

It should be noted that the illustrations and descriptions of the examples shown in the figures are for exemplary purposes only, and should not be construed limiting the disclosure. One skilled in the art will appreciate that the present disclosure contemplates various examples. Additionally, it should be understood that the concepts described above with the above-described examples may be employed alone or in combination with any of the other examples described above. It should further be appreciated that the various alternative examples described above with respect to one illustrated example can apply to all examples as described herein, unless otherwise indicated.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more examples or that one or more examples necessarily include these features, elements and/or steps. The terms “comprising,” “including,” “having,” and the like are synonymous and are used inclusively, in an open-ended fashion, and do not exclude additional elements, features, acts, operations, and so forth.

Although the disclosure has been described in detail, it should be understood that various changes, substitutions, and alterations can be made herein without departing from the spirit and scope of the present disclosure as defined by the appended claims. Additionally, any of the embodiments disclosed herein can incorporate features disclosed with respect to any of the other embodiments disclosed herein. Moreover, the scope of the present disclosure is not intended to be limited to the particular embodiments described in the specification. As one of ordinary skill in the art will readily appreciate from that processes, machines, manufacture, composition of matter, means, methods, or steps, presently existing or later to be developed that perform substantially the same function or achieve substantially the same result as the corresponding embodiments described herein may be utilized according to the present disclosure.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

It will be understood that reference herein to “a” or “one” to describe a feature such as a component or step does not foreclose additional features or multiples of the feature. For instance, reference to a device having or defining “one” of a feature does not preclude the device from having or defining more than one of the feature, as long as the device has or defines at least one of the feature. Similarly, reference herein to “one of” a plurality of features does not foreclose the invention from including two or more, up to all, of the features. For instance, reference to a device having or defining “one of a X and Y” does not foreclose the device from having both the X and Y.

1. A selective soldering machine comprising:
a selective soldering nozzle configured to provide a solder wave to solder a portion of a workpiece;
at least one image sensor configured to detect at least one property of the selective soldering nozzle and/or the solder wave in real-time; and
a controller that is configured to adjust the solder wave provided by the selective soldering nozzle based on the at least one property detected by the at least one image sensor.

2. The selective soldering machine of claim 1, wherein the controller is configured to adjust the solder wave based on at least one of a size of the selective soldering nozzle, a height of the selective soldering nozzle, a position of the selective soldering nozzle in a riser, a size of the solder wave, a height of the solder wave, a shape of the solder wave, a nozzle body flow, and/or oxidation level of the solder wave.

3. The selective soldering machine of claim 1, wherein the at least one image sensor is configured to detect at least one property of the solder wave in real-time.

4. The selective soldering machine of claim 1, wherein the controller is configured to analyze each frame of image data detected by the at least one image sensor to determine whether to adjust the solder wave.

5. The selective soldering machine of claim 1, wherein the controller is configured to adjust the solder wave in response to determining that the solder wave should be adjusted.

6. The selective soldering machine of claim 1, wherein the controller is configured to provide a prompt to an operator in response to determining that the solder wave should be adjusted.

7. The selective soldering machine of claim 1, further comprising a first solder pot that is configured to provide solder to the selective soldering nozzle.

8. The selective soldering machine of claim 1, wherein the selective soldering nozzle is a first selective soldering nozzle; and
wherein selective soldering machine further comprises:
a second selective soldering nozzle configured to provide a solder wave to solder another portion of the workpiece.

9. The selective soldering machine of claim 8, wherein at least one other image sensor is configured to detect at least one property of the solder wave, provided by the second selective soldering nozzle, in real-time.

10. The selective soldering machine of claim 8, further comprising a second solder pot that is configured to provide solder to the second selective soldering nozzle.

11. The selective soldering machine of claim 9, wherein the controller is configured to adjust the solder wave provided by the second selective soldering nozzle based on the at least one property detected by the at least one other image sensor.

12. A method of applying solder to a workpiece, the method comprising:
providing a solder wave with a selective soldering nozzle;
detecting, with at least one image sensor, at least one property of the selective soldering nozzle and/or the solder wave in real-time; and
adjusting, with a controller, the solder wave provided by the selective soldering nozzle based on the at least one property detected by the at least one image sensor.

13. The method of claim 12, wherein the controller adjusts the solder wave based on at least one of a size of the selective soldering nozzle, a height of the selective soldering nozzle, a position of the selective soldering nozzle in a riser, a size of the solder wave, height of the solder wave, a shape of the solder wave, a nozzle body flow, and/or oxidation level of the solder wave.

14. The method of claim 12, further comprising:
applying solder from the selective soldering nozzle to a target portion of a workpiece.

15. The method of claim 12, wherein the at least one image sensor detects at least one property of the solder wave in real-time.

16. The method of claim 12, wherein the controller adjusts the solder wave in response to determining that the solder wave should be adjusted.

17. The method of claim 12, wherein the controller provides a prompt to an operator in response to determining that the solder wave should be adjusted.

18. The method of claim 12, further comprising:
providing solder to the selective soldering nozzle with a first solder pot.

19. The method of am claim 12, wherein the selective soldering nozzle is a first selective soldering nozzle, and wherein the method further comprises:
providing a solder wave to solder another portion of the workpiece with a second selective soldering nozzle.

20. The method of claim 19, further comprising:
detecting at least one property of the solder wave, provided by the second selective soldering nozzle, in real-time with at least one other image sensor.
